(19) United States
(12) Patent Application Publication
(10) Pub. No.: US 2024/0321499 A1
(43) Pub. Date: Sep. 26, 2024

(54) COIL DEVICE

(71) Applicant: TDK CORPORATION, Tokyo (JP)

(72) Inventors: Toshiyuki HORIKAWA, Tokyo (JP); Shinichiro KOKUBO, Tokyo (JP); Ryoji ONO, Tokyo (JP)

(73) Assignee: TDK CORPORATION, Tokyo (JP)

(21) Appl. No.: 18/588,237

(22) Filed: Feb. 27, 2024

(30) Foreign Application Priority Data
Mar. 24, 2023 (JP) 2023-048644

(51) Int. Cl. H01F 27/08; H01F 27/26; H01F 27/28; H01F 27/32

(52) U.S. Cl. CPC H01F 27/08; H01F 27/263; H01F 27/2823; H01F 27/323

(57) ABSTRACT

A coil device including a first winding unit around which a first wire is wound, a second winding unit around which a second wire is wound, a middle leg core disposed radially inside the first winding portion and the second winding portion, an outer leg core disposed radially outside the first winding unit and the second winding unit, and a first combining core coupling the middle leg core with the outer leg core. At least one of an inner circumferential surface of the first winding portion and an inner circumferential surface of the second winding portion is in contact with an outer circumferential surface of the middle leg core.

### BACKGROUND OF THE INVENTION

### 1. Technical Field

The present invention relates to a coil device.

### 2. Description of the Related Art

JP 2014-93404 A describes a coil device including a tubular bobbin, a first winding portion and a second winding portion disposed on the outer circumferential surface of the bobbin, and an E-shaped core attached to the bobbin and including a middle leg and an outer leg. The middle leg is inserted into the through hole of the bobbin, and is disposed radially inside the first winding portion and the second winding portion. The outer leg is disposed radially outside the first winding portion and the second winding portion.

In the coil device of JP 2014-93404 A, when the above-described members are combined, for example, a space is inevitably formed between the bobbin and the middle leg. According to investigations by the present inventors, it has been found that such a space may hinder heat dissipation and miniaturization of the coil device.

### CITATION LIST

### Patent Literature

Patent Literature 1: JP 2014-93404 A

### SUMMARY OF THE INVENTION

The present invention has been made in view of such circumstances, and an object thereof is to provide a coil device that has excellent heat dissipation and can be downsized.

In order to achieve the above object, a coil device according to the present invention includes:
a first winding portion having a first wire spirally wound;
a second winding portion having a second wire spirally wound;
a middle leg core disposed radially inside the first winding portion and the second winding portion;
an outer leg core disposed radially outside the first winding portion and the second winding portion; and
a first combining core coupling the middle leg core with the outer leg core,
at least one of an inner circumferential surface of the first winding portion and an inner circumferential surface of the second winding portion is in contact with an outer circumferential surface of the middle leg core.

In the coil device according to the present invention, at least one of the inner circumferential surface of the first winding portion and the inner circumferential surface of the second winding portion is in contact with the outer circumferential surface of the middle leg core. This prevents a space from being formed between the middle leg core and at least one of the first winding portion and the second winding portion, thereby reducing the size of the coil device. This also facilitates direct heat transfer of heat generated in at least one of the first winding portion and the second winding portion to the middle leg core, thereby improving the heat dissipation of the coil device. In addition, since the bobbin is not interposed between the middle leg core and at least one of the first winding portion and the second winding portion, the coil device can be downsized by the thickness of the bobbin.

At least one of the first wire and the second wire may be directly wound around the outer circumferential surface of the middle leg core. In this case, at least one of the inner circumferential surface of the first winding portion and the inner circumferential surface of the second winding portion comes into contact with the outer circumferential surface of the middle leg core. This prevents a space from forming between the middle leg core and at least one of the first winding portion and the second winding portion, and effectively reduces the size of the coil device and improves heat dissipation.

An inner circumferential surface of the outer leg core may be in contact with at least one of the outer circumferential surface of the first winding portion and the outer circumferential surface of the second winding portion. In this case, a space is less likely formed between the outer leg core and at least one of the first winding portion and the second winding portion. This ensures a heat transfer path between the outer leg core and at least one of the first winding portion and the second winding portion, thereby effectively reducing the size of the coil device and improving its heat dissipation.

The outer leg core may be configured to be separated from the middle leg core. In this case, the first wire and the second wire can be wound around the middle leg core separated from the outer leg core. This allows the first wire and the second wire to be wound around the middle leg core without being inhibited by the outer leg core, thereby facilitating the winding operation of the first wire and the second wire.

The middle leg core may be configured to be separated from the first combining core. In this case, the first wire and the second wire can be wound around the middle leg core separated from the first combining core (that is, with the middle leg core alone). Therefore, the first wire and the second wire can be easily wound around the middle leg core.

The outer leg core may be configured to be separated from the first combining core. In this case, the outer leg core, the middle leg core, and the first combining core are separated from each other. Therefore, the outer leg core can be disposed more freely, and for example, the outer leg core can be disposed such that the inner circumferential surface of the outer leg core is in contact with at least one of the outer circumferential surface of the first winding portion and the outer circumferential surface of the second winding portion. In this case, a space is less likely formed between the outer leg core and at least one of the first winding portion and the second winding portion, and a heat transfer path can be secured between the outer leg core and at least one of the first winding portion and the second winding portion. This effectively reduces the size of the coil device and improves heat dissipation.

The middle leg core includes a first split core having the first wire spirally wound, and a second split core formed separately from the first split core and having the second wire spirally wound, and a first gap may be formed between the first split core and the second split core. In this case, the distance between the first winding portion and the second winding portion can be adjusted by the first gap, and the coupling between the first winding portion and the second winding portion can be adjusted. Accordingly, leakage of the coil device can be optimized.

A second combining core facing the first combining core may be further provided along the axial direction of the middle leg core, and a second gap may be formed between an axial end of the middle leg core and the second combining core. In this case, the coupling between the first winding portion and the second winding portion can be adjusted by the second gap, and the leakage of the coil device can be optimized.

At least one of the first wire and the second wire is an insulated coated wire, and a coating of the insulating coated wire of at least one of the first winding portion and the second winding portion may be covered with a resin. In this case, the shape of at least one of the first winding portion and the second winding portion can be maintained by the resin. This prevents unwinding of at least one of the first winding portion and the second winding portion, thereby improving the magnetic properties of the coil device.

A case accommodating the middle leg core and the outer leg core may be further provided, the case may be filled with a heat dissipation resin so as to cover the first winding portion and the second winding portion. In this case, the heat of the first winding portion, the second winding portion, and the core can be dissipated via the heat dissipation resin and the case.

A first combining core coupling the middle leg core with the outer leg core, a second combining core facing the first combining core along the axial direction of the middle leg core, and a heat sink having a top plate portion disposed along the top surface of the second combining core and a side portion disposed along a side surface of the second combining core perpendicular to a top surface may be further provided. In this case, in particular, the heat of the second combining core can be dissipated via the top plate portion and the side portion of the heat sink.

### BRIEF DESCRIPTION OF THE DRAWINGS

FIG. 1 is a perspective view of a coil device according to a first embodiment of the present invention;

FIG. 2 is an exploded perspective view of the coil device illustrated in FIG. 1;

FIG. 3 is a cross-sectional view taken along line III-III illustrated in FIG. 1;

FIG. 4 is a partially exploded perspective view of the coil device illustrated in FIG. 1, in which a case and a heat dissipation resin are omitted;

FIG. 5 is a side view of a first winding portion, a second winding portion, various cores, and a heat sink illustrated in FIG. 4;

FIG. 6 is a side view of the first winding portion and the second winding portion wound around the middle leg illustrated in FIG. 2; and

FIG. 7 is a perspective view of a coil device according to a second embodiment of the present invention.

### DETAILED DESCRIPTION

Hereinafter, embodiments of the present invention will be described with reference to the drawings. Note that the illustrated contents are merely schematic and exemplary for understanding the present invention, and the appearance, the dimensional ratio, and the like may be different from the actual ones. Further, the present invention is not limited to the following embodiments.

### First Embodiment

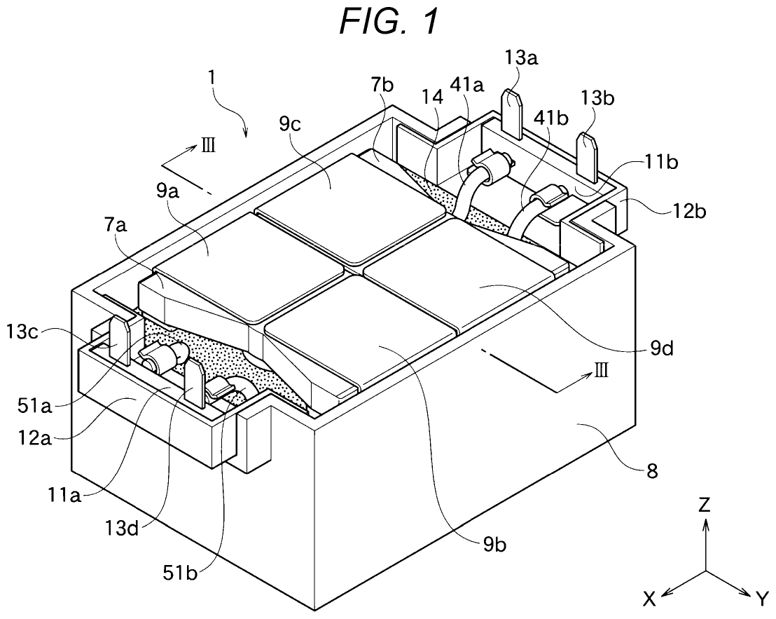

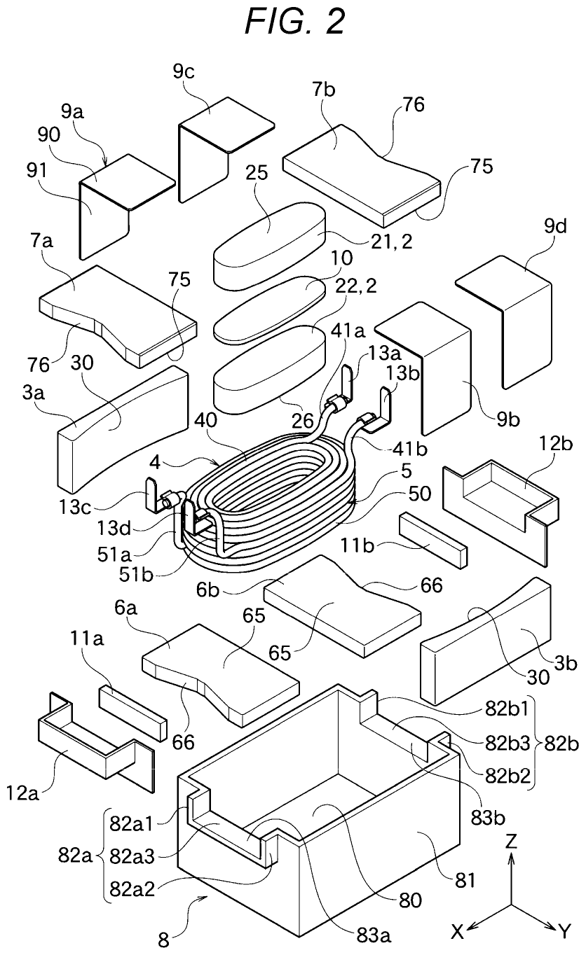

A coil device 1 according to the first embodiment of the present invention illustrated in FIG. 1 functions as, for example, a leakage transformer, and is used in power supply circuits of vehicle chargers and various electric devices. As illustrated in FIG. 2, the coil device 1 includes a middle leg core 2, outer leg cores 3a and 3b, first combining cores 6a and 6b, a first winding portion 40, and a second winding portion 50. The coil device 1 further includes second combining cores 7a and 7b, a case 8, heat sinks 9a to 9d, terminal fixing plates 11a and 11b, pedestals 12a and 12b, terminals 13a to 13d, and a heat dissipation resin 14 (FIG. 1), but these members are not essential and may be omitted.

In FIG. 2 and other figures, the X axis is an axis parallel to the direction in which the first combining core 6a and the first combining core 6b face each other. The Y axis is an axis parallel to the direction in which the outer leg core 3a and the outer leg core 3b face each other. The Z axis is an axis perpendicular to the X axis and the Y axis. The Z axis is also an axis parallel to the axial direction of the middle leg core 2. In the following description, for each of the X axis, the Y axis, and the Z axis, the direction toward the center of the coil device 1 is referred to as inside and the direction away from the center of the coil device 1 is referred to as outside.

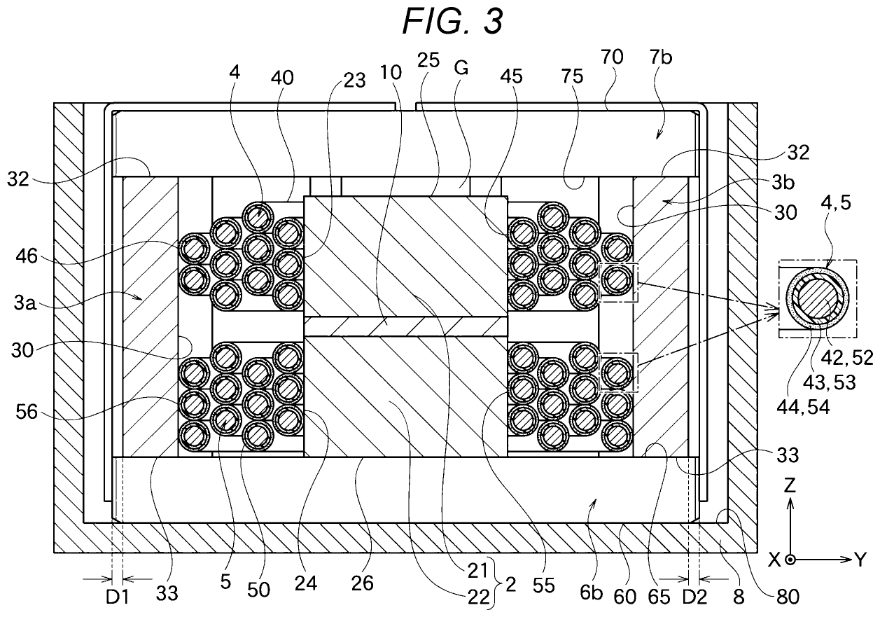

As illustrated in FIG. 2, the first winding portion 40 is formed by spirally winding the first wire 4. The second winding portion 50 is formed by spirally winding the second wire 5. The winding axes of the first winding portion 40 and the second winding portion 50 are parallel to the Z axis and are disposed perpendicular to the mounting substrate (not illustrated). As illustrated in FIG. 3, the first winding portion 40 and the second winding portion 50 are disposed apart from each other along the Z axis. The first winding portion 40 and the second winding portion 50 may be separated from each other in the Z axis direction by, for example, a ring-shaped partition wall plate having an insulating property to avoid mutual contact. However, the first winding portion 40 and the second winding portion 50 may be disposed to be in contact with each other along the Z axis. One of the first winding portion 40 and the second winding portion 50 is a primary coil, and the other is a secondary coil.

The first wire 4 and the second wire 5 are self bonding wires. As illustrated in the enlarged view in FIG. 3, the first wire 4 includes a core portion 42, a coating 43, and a fusion layer 44. The second wire 5 includes a core portion 52, a coating 53, and a fusion layer 54. The core portions 42 and 52 are conductive core wires such as round wires, rectangular wires, stranded wires, litz wires, and braided wires made of copper or the like. The coatings 43 and 53 are insulating coatings and are not particularly limited, but are made of a resin such as polyurethane, polyamideimide, polyimide, or polyester. The fusion layers 44 and 54 are not particularly limited, but are made of, for example, a thermoplastic resin or a thermosetting resin such as a polyamide-based resin or a polyimide-based resin. The melting points of the fusion layers 44 and 54 are lower than the melting points of the coatings 43 and 53.

Although not illustrated in detail, the fusion layers 44 and 54 are melted by heating the first wire 4 and the second wire 5. As a result, the turns constituting the first winding portion 40 are fixed (bonded) to each other by the fusion layer 44 (adhesive layer), and the first winding portion 40 is covered with the fusion layer 44 over the coating 43. This allows the first winding portion 40 to be self-retaining and stabilizes the shape of the first winding portion 40. In addition, the turns constituting the second winding portion 50 are fixed (bonded) to each other by the fusion layer 54 (adhesive layer), and the second winding portion 50 is covered with the fusion layer 54 over the coating 53. This allows the second winding portion 50 to be self-retaining and stabilizes the shape of the second winding portion 50. In the present embodiment, both the first wire 4 and the second wire 5 are self bonding wires, but only one of the first wire 4 and the second wire 5 may be a self bonding wire.

At least one of the first wire 4 and the second wire 5 may be an insulated coated wire that is not a self bonding wire. Further, the first winding portion 40 may be covered with a resin over the coating 43 (or the core portion 42) by, for example, resin impregnation or varnish impregnation. Similarly, the second winding portion 50 may be covered with a resin over the coating 53 (or the core portion 52) by, for example, resin impregnation or varnish impregnation. In this case, the shapes of the first winding portion 40 and the second winding portion 50 can be maintained by the resin. This prevents unwinding of the first winding portion 40 and the second winding portion 50 and improves the magnetic properties of the coil device 1.

a diameter of each of the first wire 4 and the second wire 5 is, for example, 1.0 to 3.0 mm. Diameters of the first wire 4 and the second wire 5 may be equal to each other or may be different from each other. For example, the diameter of one of the first wire 4 and the second wire 5 having a larger current may be made larger than the diameter of the other wire.

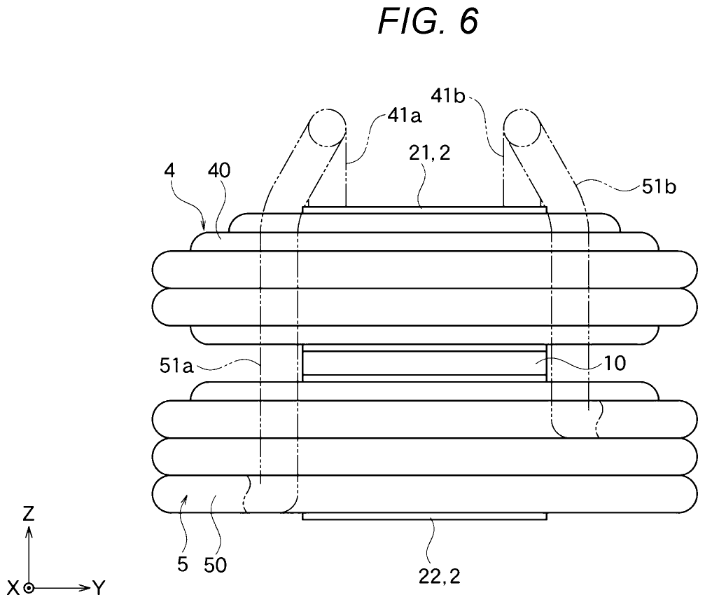

As illustrated in FIG. 2, the leadout portions 41a and 41b are drawn out from the first winding portion 40. The leadout portions 51a and 51b are drawn out so as to be raised from the second winding portion 50 (see FIG. 6).

The middle leg core 2 includes a first split core 21 and a second split core 22 formed separately from the first split core 21. The first split core 21 and the second split core 22 are combined in the Z axis direction via the gap member 10 (FIG. 3). In the present embodiment, the middle leg core 2 includes split cores, but may include one core. In addition, the number of split cores may be three or more.

The first split core 21 is formed of a columnar body, and the cross-sectional shape of the first split core 21 is elliptical. However, the cross-sectional shape of the first split core 21 may be circular, rectangular, or other polygonal. The second split core 22 includes a columnar body and has the same shape as the first split core 21. However, the shape of the second split core 22 may be different from the shape of the first split core 21. The axial length of the second split core 22 may be longer (or shorter) than the axial length of the first split core 21.

The material of the first split core 21 and the second split core 22 is not particularly limited, but is a synthetic resin in which ferrite particles or metal magnetic particles are dispersed. The ferrite particles are not particularly limited, and examples thereof include Ni—Zn-based ferrite and Mn—Zn-based ferrite. The metal magnetic particles are not particularly limited, and examples thereof include Fe—Ni alloy powder, Fe—Si alloy powder, Fe—Si—Cr alloy powder, Fe—Co alloy powder, Fe—Si—Al alloy powder, and amorphous iron. The synthetic resin is not particularly limited, and examples thereof include epoxy resins, phenol resins, polyester resins, polyurethane resins, polyimide resins, and silicon resins. The materials of the first split core 21 and the second split core 22 are the same, but may be different.

The second split core 22 is disposed on the first combining cores 6a and 6b so as to overlap the first combining core 6a and the first combining core 6b. The second split core 22 is disposed at the center of the first combining cores 6a and 6b in the Y axis direction, but the position of the second split core 22 may be displaced with respect to the center of the first combining cores 6a and 6b in the Y axis direction.

As illustrated in FIG. 3, the first wire 4 is wound around the outer circumferential surface 23 of the first split core 21 to form the first winding portion 40. In addition, the second wire 5 is wound around the outer circumferential surface 24 of the second split core 22 to form the second winding portion 50. Thus, the middle leg core 2 is disposed radially inside the first winding portion 40 and the second winding portion 50.

The gap member 10 is an insulating sheet, and is disposed (sandwiched) between the first split core 21 and the second split core 22. The cross-sectional shape of the gap member 10 is the same as the cross-sectional shape of the first split core 21 or the second split core 22. The gap member 10 is made of, for example, plastic such as PPS, PET, PBT, or LCP, or other insulating member (preferably a heat-resistant material). The thickness of the gap member 10 is smaller than the thickness of the first split core 21 or the second split core 22. The thickness of the gap member 10 along the Z axis is, for example, 1 to 3 mm. Further, the thickness of the gap member 10 is smaller than the diameter of the first wire 4 or the second wire 5, but may be equal to or larger than this.

In the present embodiment, a gap (region where no core is disposed) is formed between the first split core 21 and the second split core 22 by the gap member 10, and the distance between the first split core 21 and the second split core 22 along the Z axis can be adjusted. Therefore, the distance along the Z axis between the first winding portion 40 disposed in the first split core 21 and the second winding portion 50 disposed in the second split core 22 can be adjusted. Thus, the coupling between the first winding portion 40 and the second winding portion 50 can be adjusted, and the leakage of the coil device 1 can be optimized.

Both the first winding portion 40 and the second winding portion 50 are disposed so as not to overlap with the gap member 10. That is, the first winding portion 40 is disposed on one side of the gap member 10 along the Z axis. The second winding portion 50 is disposed on the other side of the gap member 10 along the Z axis. This makes it easy to obtain the effect of adjusting the coupling between the first winding portion 40 and the second winding portion 50 described above.

The gap member 10 may be omitted, and an air layer (space) may be formed between the first split core 21 and the second split core 22. For example, the first split core 21 is combined to the second combining cores 7a and 7b to form a T-shaped core, and the second split core 22 is combined to the first combining cores 6a and 6b to form a T-shaped core, thereby forming a gap (air layer) between the first split core 21 and the second split core 22.

The length of the first split core 21 along the Z axis is equal to the length of the first winding portion 40 along the Z axis, but may be longer than this. The length of the second split core 22 along the Z axis is equal to the length of the second winding portion 50 along the Z axis, but may be longer than this.

As illustrated in FIG. 2, each of the outer leg cores 3a and 3b is a plate-shaped core that is thin in the Y axis direction. The outer leg core 3a and the outer leg core 3b face each other in the Y axis direction. The outer leg core 3a and the outer leg core 3b have the same shape, but may have different shapes. The material of the outer leg cores 3a and 3b is not particularly limited, but is a synthetic resin in which ferrite particles or metal magnetic particles are dispersed. The materials of the outer leg cores 3a and 3b are the same, but may be different. The material of the outer leg cores 3a and 3b is the same as the material of the middle leg core 2, but may be different.

The outer leg core 3a is disposed on the first combining cores 6a and 6b so as to overlap the first combining core 6a and the first combining core 6b on one side in the Y axis direction with respect to the middle leg core 2. The outer leg core 3b is disposed on the first combining cores 6a and 6b so as to overlap the first combining core 6a and the first combining core 6b on the other side in the Y axis direction with respect to the middle leg core 2.

As illustrated in FIG. 3, the outer leg core 3a is disposed radially outside the first winding portion 40 and the second winding portion 50. The outer leg core 3b is disposed radially outside the first winding portion 40 and the second winding portion 50. Therefore, at least a part of the first winding portion 40 is sandwiched between the middle leg core 2 and the outer leg core 3a and is sandwiched between the middle leg core 2 and the outer leg core 3b. At least a part of the second winding portion 50 is sandwiched between the middle leg core 2 and the outer leg core 3a and is sandwiched between the middle leg core 2 and the outer leg core 3b.

The outer leg core 3a includes one core, but may include cores. The outer leg core 3b includes one core, the outer leg core 3b may include cores. For example, similarly to the middle leg core 2, the outer leg core 3a may include split cores disposed along the Z axis via at least one gap member. In addition, the outer leg core 3b may include split cores disposed along the Z axis via at least one gap member.

As illustrated in FIG. 2, the inner circumferential surface 30 of the outer leg core 3a is a curved surface, and is curved along the outer circumferential surface of the first winding portion 40 and the outer circumferential surface of the second winding portion 50. The radius of curvature of the inner circumferential surface 30 of the outer leg core 3a is equal to the radius of curvature of the outer circumferential surface of each of the first winding portion 40 and the second winding portion 50, but may be smaller or larger than this.

The inner circumferential surface 30 of the outer leg core 3b is a curved surface, and is curved along the outer circumferential surface of the first winding portion 40 and the outer circumferential surface of the second winding portion 50. The radius of curvature of the inner circumferential surface 30 of the outer leg core 3b is equal to the radius of curvature of the outer circumferential surface of each of the first winding portion 40 and the second winding portion 50, but may be smaller or larger than this.

The thickness (maximum thickness or average thickness) of the outer leg core 3a or 3b in the Y axis direction is smaller than the thickness (maximum thickness or average thickness) of the middle leg core 2 in the Y axis direction, but may be equal to or larger than this.

Each of the first combining cores 6a and 6b is a plate-shaped core that is flat in the Z axis direction. The first combining core 6a and the first combining core 6b have the same shape, but may have different shapes. The materials of the first combining cores 6a and 6b are not particularly limited, but are synthetic resins in which ferrite particles or metal magnetic particles are dispersed. The materials of the first combining cores 6a and 6b are the same, but may be different. The materials of the first combining cores 6a and 6b are the same as the material of the other cores (the middle leg core 2, the outer leg core 3a, and the outer leg core 3b), but may be different.

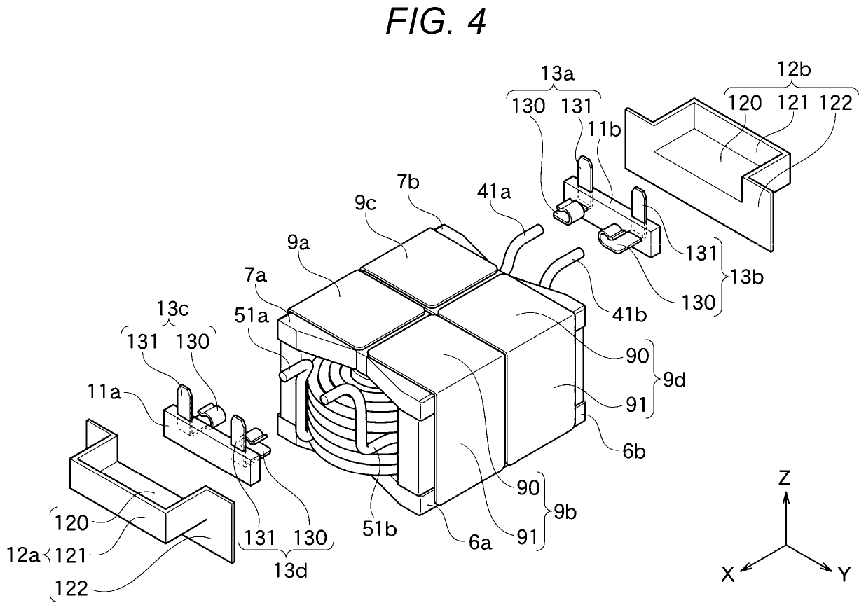

The first combining cores 6a and 6b are disposed adjacent to each other in the X axis direction (see FIG. 4). The first combining core 6a and the first combining core 6b may be in contact with each other along the X axis. Alternatively, a space may be formed between the first combining core 6a and the first combining core 6b along the X axis. The first combining cores 6a and 6b are disposed so as to be orthogonal to the middle leg core 2. The first combining cores 6a and 6b are disposed so as to be orthogonal to the outer leg cores 3a and 3b.

As illustrated in FIG. 3, the first combining core 6b (as well as the first combining core 6a) is disposed adjacent to the second winding portion 50 along the Z axis. More specifically, the first combining core 6b is disposed between the second winding portion 50 and the bottom portion 80 of the case 8. The outer surface 60 of the first combining core 6b is in direct contact with the bottom portion 80 of the case 8. However, an insulating or conductive member may be disposed between the outer surface 60 and the bottom portion 80.

On the inner surface 65 of the first combining core 6b, the middle leg core 2 (second split core 22), the outer leg core 3a, and the outer leg core 3b are disposed. Therefore, the first combining core 6b combines the middle leg core 2 (second split core 22), the outer leg core 3a, and the outer leg core 3b.

Although not illustrated in detail, the middle leg core 2 (second split core 22), the outer leg core 3a, and the outer leg core 3b are disposed on the inner surface 65 of the first combining core 6a illustrated in FIG. 2. Therefore, the first combining core 6a combines the middle leg core 2 (second split core 22), the outer leg core 3a, and the outer leg core 3b.

As illustrated in FIG. 3, the bottom surface 26 of the second split core 22 is in direct contact with the inner surface 65 of the first combining core 6b (as well as the first combining core 6a). However, an insulating or conductive member may be disposed between the bottom surface 26 of the second split core 22 and the inner surface 65 of the first combining core 6b (first combining core 6a).

The bottom surface 33 of the outer leg core 3a is in direct contact with the inner surface 65 of the first combining core 6b (as well as the first combining core 6a). Similarly, the bottom surface 33 of the outer leg core 3b is in direct contact with the inner surface 65 of the first combining core 6b (as well as the first combining core 6a). However, an insulating or conductive member may be disposed between the bottom surface 33 of the outer leg core 3a and the inner surface 65 of the first combining core 6b (first combining core 6a). Similarly, an insulating or conductive member may be disposed between the bottom surface 33 of the outer leg core 3b and the inner surface 65 of the first combining core 6b (first combining core 6a).

As illustrated in FIG. 2, a recess 66 having a V-shape is formed on an outer side surface of the first combining core 6a in the X axis direction. The recess 66 is also formed on an outer side surface of the first combining core 6b in the X axis direction. The recess 66 may be omitted from the first combining cores 6a and 6b.

Although the first combining core 6a and the first combining core 6b are configured to be separated, they may be integrated. Alternatively, the first combining core 6a may be further divided into cores, and the first combining core 6b may be further divided into cores.

Each of the second combining cores 7a and 7b is a plate-shaped core that is flat in the Z axis direction. The second combining core 7a and the second combining core 7b have the same shape, but may have different shapes. The material of the second combining cores 7a and 7b is not particularly limited, but is a synthetic resin in which ferrite particles or metal magnetic particles are dispersed. The materials of the second combining cores 7a and 7b are the same, but may be different. The material of the second combining cores 7a and 7b is the same as the material of the other cores (the middle leg core 2, the outer leg core 3a and the outer leg core 3b, and the first combining cores 6a and 6b), but may be different.

The second combining cores 7a and 7b are disposed adjacent to each other in the X axis direction (see FIG. 4). The second combining core 7a and the second combining core 7b may be in contact with each other along the X axis. Alternatively, a space may be formed along the X axis between the second combining core 7a and the second combining core 7b. The second combining cores 7a and 7b are disposed so as to be orthogonal to the middle leg core 2. The second combining cores 7a and 7b are disposed so as to be orthogonal to the outer leg cores 3a and 3b.

The second combining cores 7a and 7b face the first combining cores 6a and 6b along the axial direction of the middle leg core 2. As illustrated in FIG. 3, the second combining core 7b (as well as the second combining core 7a) is disposed adjacent to the first winding portion 40 along the Z axis.

The outer leg cores 3a and 3b are disposed on an inner surface 75 of the second combining core 7b (as well as the second combining core 7a). Therefore, the second combining core 7b combines the outer leg core 3a with the outer leg core 3b. The second combining core 7a combines the outer leg core 3a with the outer leg core 3b.

The top surface 25 of the first split core 21 is not in contact with the inner surface 75 of the second combining core 7b. Although not illustrated in detail, the top surface 25 of the first split core 21 is not in contact with the inner surface 75 of the second combining core 7a. That is, a gap G is formed between the top surface 25 of the first split core 21 (the axial end of the middle leg core 2) and the inner surface 75 of the second combining core 7b. Similarly, a gap G is formed between the top surface 25 of the first split core 21 (the axial end of the middle leg core 2) and the inner surface 75 of the second combining core 7a.

Although an air layer (space) is formed in the gap G, the gap G may be filled with, for example, a heat dissipation resin 14 (FIG. 1). Alternatively, an insulating member may be disposed in the gap G. In the present embodiment, the coupling between the first winding portion 40 and the second winding portion 50 can be adjusted by the gap G, and the leakage of the coil device 1 can be optimized. The top surface 25 of the first split core 21 may be in direct contact with the inner surface 75 of the second combining core 7a and the inner surface 75 of the second combining core 7b.

The top surface 32 of the outer leg core 3a is in direct contact with the inner surface 75 of the second combining core 7b (as well as the second combining core 7a). Similarly, the top surface 32 of the outer leg core 3b is in direct contact with the inner surface 75 of the second combining core 7b (as well as the second combining core 7a). However, an insulating or conductive member may be disposed between the top surface 32 of the outer leg core 3a and the inner surface 75 of the second combining core 7b (second combining core 7a). An insulating or conductive member may be disposed between the top surface 32 of the outer leg core 3b and the inner surface 75 of the second combining core 7b (second combining core 7a).

As illustrated in FIG. 2, a recess 76 having a V-shape is formed on an outer side surface of the second combining core 7a in the X axis direction. The recess 76 is also formed on an outer side surface of the second combining core 7b in the X axis direction. The recess 76 may be omitted from the second combining cores 7a and 7b.

In the present embodiment, the second combining core 7a and the second combining core 7b are configured separately, but may be integrated. Alternatively, the second combining core 7a may be further divided into cores, and the second combining core 7b may be further divided into cores.

The middle leg core 2, the outer leg core 3a, the outer leg core 3b, and the first combining cores 6a and 6b constitute an E-shaped core. The second combining cores 7a and 7b constitute an I-shaped core. That is, in the coil device 1 of the present embodiment, the E-shaped core and the I-shaped core are combined.

In the present embodiment, these cores are combined so that the outer leg cores 3a and 3b are disposed in the space between the combined body of the first combining cores 6a and 6b and the combined body of the second combining cores 7a and 7b.

The outer leg core 3a is configured to be separated from the middle leg core 2, and the outer leg core 3b is configured to be separated from the middle leg core 2. Therefore, the first wire 4 and the second wire 5 can be wound around the middle leg core 2 (the first split core 21 and the second split core 22) separated from the outer leg cores 3a and 3b. This allows the first wire 4 and the second wire 5 to be wound around the middle leg core 2 without being inhibited by the outer leg cores 3a and 3b, thereby facilitating the winding operation of the first wire 4 and the second wire 5.

The outer leg core 3a may be integrated with the middle leg core 2. For example, the outer leg core 3a may be integrated with the middle leg core 2 via the first combining cores 6a and 6b. In this case, the outer leg core 3a, the middle leg core 2, and the first combining cores 6a and 6b form a U-shaped core.

Similarly, outer leg core 3b may be integrated with middle leg core 2. For example, the outer leg core 3b may be integrated with the middle leg core 2 via the first combining cores 6a and 6b. In this case, the outer leg core 3b, the middle leg core 2, and the first combining cores 6a and 6b form a U-shaped core.

The middle leg core 2 is configured to be separated from the first combining cores 6a and 6b. Therefore, the first wire 4 and the second wire 5 can be wound around the middle leg core 2 (the first split core 21 and the second split core 22) separated from the first combining cores 6a and 6b (that is, with the middle leg core 2 alone). This makes it easier to wind the first wire 4 and the second wire 5 around the middle leg core 2. The middle leg core 2 may be integrated with the first combining cores 6a and 6b. In this case, the middle leg core 2 and the first combining cores 6a and 6b can form a T-shaped core.

The outer leg cores 3a and 3b are configured to be separated from the first combining cores 6a and 6b, but may be integrated with the first combining cores 6a and 6b. In this case, the outer leg cores 3a and 3b and the first combining cores 6a and 6b can form a U-shaped core.

As illustrated in FIG. 3, the inner circumferential surface 45 of the first winding portion 40 is in contact with the outer circumferential surface 23 of the first split core 21. This is because the first wire 4 is directly wound around the outer circumferential surface 23 of the first split core 21. All of the turns forming the inner circumferential surface 45 of the first winding portion 40 are in contact with the outer circumferential surface 23, but any of the turns may not be in contact with the outer circumferential surface 23.

In addition, the inner circumferential surface 55 of the second winding portion 50 is in contact with the outer circumferential surface 24 of the second split core 22. This is because the second wire 5 is directly wound around the outer circumferential surface 24 of the second split core 22. All of the turns forming the inner circumferential surface 55 of the second winding portion 50 are in contact with the outer circumferential surface 24, but any of the turns may not be in contact with the outer circumferential surface 24.

One of the first winding portion 40 and the second winding portion 50 may not be in contact with the outer circumferential surface of the middle leg core 2. In this case, either the first winding portion 40 or the second winding portion 50 may be an air-core coil.

The inner circumferential surface 30 of the outer leg core 3a and the inner circumferential surface 30 of the outer leg core 3b are in contact with the outer circumferential surface 46 of the first winding portion 40. All of the turns forming the outer circumferential surface 46 of the first winding portion 40 are in contact with the inner circumferential surface 30 of the outer leg core 3a, but any of the turns may not be in contact with the inner circumferential surface 30. Similarly, all of the turns forming the outer circumferential surface 46 of the first winding portion 40 are in contact with the inner circumferential surface 30 of the outer leg core 3b, but any of the turns may not be in contact with the inner circumferential surface 30. Either the inner circumferential surface 30 of the outer leg core 3a or the inner circumferential surface 30 of the outer leg core 3b may not be in contact with the outer circumferential surface 46 of the first winding portion 40.

The inner circumferential surface 30 of the outer leg core 3a and the inner circumferential surface 30 of the outer leg core 3b are in contact with the outer circumferential surface 56 of the second winding portion 50. All of the turns forming the outer circumferential surface 56 of the second winding portion 50 are in contact with the inner circumferential surface 30 of the outer leg core 3a, but any of the turns may not be in contact with the inner circumferential surface 30. Similarly, all of the turns forming the outer circumferential surface 56 of the second winding portion 50 are in contact with the inner circumferential surface 30 of the outer leg core 3b, but any of the turns may not be in contact with the inner circumferential surface 30. Either the inner circumferential surface 30 of the outer leg core 3a or the inner circumferential surface 30 of the outer leg core 3b may not be in contact with the outer circumferential surface 56 of the second winding portion 50.

As illustrated in FIG. 2, the outer leg core 3a is configured to be separated from the first combining cores 6a and 6b and the second combining cores 7a and 7b. Therefore, as illustrated in FIG. 3, the outer leg core 3a can be disposed at position separated from one end of the first combining core 6b (first combining core 6a) in the Y axis direction by a distance D1 to the other side in the Y axis direction. As a result, the inner circumferential surface 30 of the outer leg core 3a can be in contact with the outer circumferential surface 46 of the first winding portion 40 and the outer circumferential surface 56 of the second winding portion 50.

Similarly, as illustrated in FIG. 2, the outer leg core 3b is configured to be separated from the first combining cores 6a and 6b and the second combining cores 7a and 7b. Therefore, as illustrated in FIG. 3, the outer leg core 3b can be disposed at position separated from one end of the first combining core 6b (first combining core 6a) in the Y axis direction by a distance D2 to the other side in the Y axis direction. As a result, the inner circumferential surface 30 of the outer leg core 3b can be in contact with the outer circumferential surface 46 of the first winding portion 40 and the outer circumferential surface 56 of the second winding portion 50.

Either the outer circumferential surface 46 of the first winding portion 40 or the outer circumferential surface 56 of the second winding portion 50 may be in contact with the inner circumferential surface 30 of the outer leg core 3a and/or the inner circumferential surface 30 of the outer leg core 3b.

The second winding portion 50 is disposed at a distance from the inner surface 65 of the first combining core 6b (first combining core 6a) along the Z axis, but may be in contact with the inner surface 65 of the first combining core 6b (first combining core 6a). The first winding portion 40 is disposed at a distance from the inner surface 75 of the second combining core 7b (second combining core 7a) along the Z axis, but may be in contact with the inner surface 75 of the second combining core 7b (second combining core 7a).

As illustrated in FIG. 2, the case 8 includes, for example, a bottom portion 80, a side portion 81, protrusions 82a and 82b, and recesses 83a and 83b. The case 8 is made of aluminum or other metal having excellent cooling properties. The case 8 accommodates at least the middle leg core 2, the outer leg cores 3a and 3b, the first combining cores 6a and 6b, the second combining cores 7a and 7b, the first winding portion 40, and the second winding portion 50.

The protrusion 82a is formed at one end of the side portion 81 in the X axis direction, and protrudes outward in the X axis direction from the outer surface of the side portion 81. The protrusion 82a has a first wall portion 82a1, a second wall portion 82a2, and a bottom wall portion 82a3. The first wall portion 82al and the second wall portion 82a2 face each other along the Y axis. The bottom wall portion 82a3 couples the first wall portion 82al with the second wall portion 82a2. The first wall portion 82al, the second wall portion 82a2, and the bottom wall portion 82a3 are continuous so as to form a C shape. The recess 83a is a recess defined by the first wall portion 82a1, the second wall portion 82a2, and the bottom wall portion 82a3, and is formed inside the protrusion 82a.

The protrusion 82b is formed at the other end of the side portion 81 in the X axis direction, and protrudes outward in the X axis direction from the outer surface of the side portion 81. The protrusion 82b includes a first wall portion 82b1, a second wall portion 82b2, and a bottom wall portion 82b3. The first wall portion 82b1 and the second wall portion 82b2 face each other along the Y axis. The bottom wall portion 82b3 couples the first wall portion 82b1 with the second wall portion 82b2. The first wall portion 82b1, the second wall portion 82b2, and the bottom wall portion 82b3 are continuous so as to form a C shape. The recess 83b is a recess defined by the first wall portion 82b1, the second wall portion 82b2, and the bottom wall portion 82b3, and is formed inside the protrusion 82b.

As illustrated in FIGS. 1 and 2, the inside of the case 8 is filled with the heat dissipation resin 14. The heat dissipation resin 14 is filled inside the case 8 so as to cover (immerse) at least the first winding portion 40, the second winding portion 50, the middle leg core 2, the outer leg cores 3a and 3b, and the first combining cores 6a and 6b. The heat dissipation resin 14 is made of a silicone resin, a urethane resin, an epoxy resin, or the like. The heat dissipation resin 14 is filled near the opening of the case 8, for example, up to about 70 to 90% of the height of the side portion 81 along the Z axis. In the example illustrated in FIG. 1, the heat dissipation resin 14 does not cover the second combining cores 7a and 7b, but may cover the second combining cores 7a and 7b.

In the present embodiment, the heat of the first winding portion 40, the second winding portion 50, the middle leg core 2, the outer leg cores 3a and 3b, and the first combining cores 6a and 6b can be efficiently dissipated to the outside via the heat dissipation resin 14 and the case 8, and the cooling efficiency of the coil device 1 can be enhanced.

As illustrated in FIG. 4, the terminals 13a to 13d have the same shape, and each have a wire connecting portion 130 and a connection portion 131. The terminals 13a and 13b are integrally molded with the terminal fixing plate 11b, but may be retrofitted to the terminal fixing plate 11b. The terminals 13c and 13d are integrally molded with the terminal fixing plate 11a, but may be configured to be retrofitted to the terminal fixing plate 11a. In the example illustrated in FIG. 4, a part of the wire connecting portion 130 and a part of the connection portion 131 are embedded in the terminal fixing plate 11a or 11b.

The leadout portion 41a is connected to the wire connecting portion 130 of the terminal 13a while being caulked. The leadout portion 41b is connected to the wire connecting portion 130 of the terminal 13b while being caulked. The leadout portion 51a is connected to the wire connecting portion 130 of the terminal 13c while being caulked. The leadout portion 51b is connected to the wire connecting portion 130 of the terminal 13d while being caulked. The leadout portions 41a, 41b, 51a, and 51b may be welded to the wire connecting portion 130. Alternatively, the leadout portions 41a, 41b, 51a, and 51b may be connected to the wire connecting portion 130 by, for example, laser welding, solder, a conductive adhesive, thermocompression bonding, ultrasonic bonding, resistance brazing, ultraviolet curing resin bonding, or the like.

The connection portion 131 is connected to, for example, a mounting substrate. The connection portion 131 protrudes along the Z axis, but may protrude along the X axis or the Y axis.

Each of the terminal fixing plates 11a and 11b is a plate body having a rectangular parallelepiped shape, and is made of, for example, an insulating member. The pedestals 12a and 12b are attached to the case 8 illustrated in FIG. 2 (see FIG. 1). As illustrated in FIGS. 2 and 4, the pedestals 12a and 12b each have a bottom portion 120, an enclosure portion 121, and a case fixing portion 122.

The bottom portion 120 is a plate body having a rectangular shape in plan view. The enclosure portion 121 and the case fixing portion 122 protrude from the outer edge of the bottom portion 120 along the Z axis. The enclosure portion 121 is disposed along the first side to the third side (one long side and two short sides) of the bottom portion 120, and extends to form a C shape. The case fixing portion 122 is disposed along the fourth side (long side) of the bottom portion 120, and protrudes toward the side opposite to the enclosure portion 121. A part of the case fixing portion 122 is located on both sides of the enclosure portion 121 in the Y axis direction.

The terminal fixing plate 11a is disposed on the bottom portion 120 of the pedestal 12a, and the terminal fixing plate 11b is disposed on the bottom portion 120 of the pedestal 12b (see FIG. 1). The pedestal 12a is disposed in the recess 83a formed inside the protrusion 82a of the case 8 (see FIG. 1). The pedestal 12b is disposed in the recess 83b formed inside the protrusion 82b of the case 8 (see FIG. 1). The case fixing portion 122 is fixed (engaged) to the inner surface of the side portion 81 of the case 8 (see FIG. 1).

As illustrated in FIG. 2, the heat sinks 9a and 9b have the same shape, and are attached to the second combining core 7a by, for example, an adhesive or a tape. Further, the heat sinks 9c and 9d have the same shape, and are attached to the second combining core 7b by, for example, an adhesive or a tape. The heat sinks 9a to 9d are made of metal such as aluminum, copper, or silver, or resin. The thickness of the heat sinks 9a to 9d is 0.5 to 2 mm.

As illustrated in FIG. 4, the heat sink 9a is attached to one side of the second combining core 7a in the Y axis direction, and the heat sink 9b is attached to the other side of the second combining core 7a in the Y axis direction. The heat sinks 9a and the heat sink 9b are separated from each other along the Y axis.

The heat sink 9c is attached to one side of the second combining core 7b in the Y axis direction, and the heat sink 9d is attached to the other side of the second combining core 7b in the Y axis direction. The heat sink 9c and the heat sink 9d are separated from each other along the Y axis.

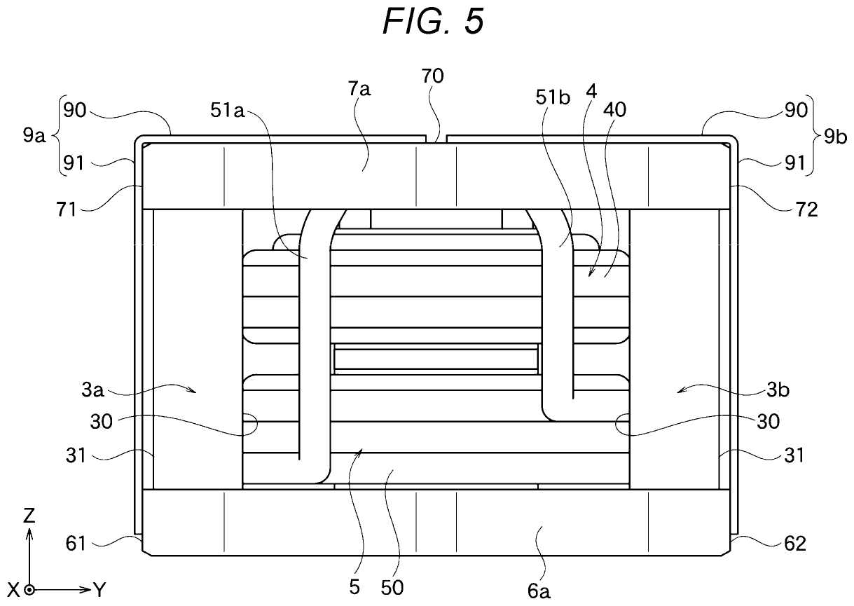

As illustrated in FIG. 2, each of the heat sinks 9a to 9d has an L shape, and includes a top plate portion 90 and a side portion 91. In the present embodiment, in particular, the heat of the second combining cores 7a and 7b can be dissipated via the top plate portion 90 and the side portion 91. As illustrated in FIG. 5, the top plate portion 90 extends along the outer surface 70 while being in contact with the outer surface (top surface) 70 of the second combining core 7a (second combining core 7b). The side portion 91 is connected to one end of the top plate portion 90 in the Y axis direction, and extends along the Z axis so as to be orthogonal to the top plate portion 90.

The side portion 91 of the heat sink 9a extends along the first side surface 71 of the second combining core 7a, the outer side surface 31 of the outer leg core 3a, and the first side surface 61 of the first combining core 6a. The side portion 91 of the heat sink 9a is in contact with the first side surface 71 and the first side surface 61, but may be separated from the first side surface 71 and the first side surface 61.

The side portion 91 of the heat sink 9b extends along the second side surface 72 of the second combining core 7a, the outer side surface 31 of the outer leg core 3b, and the second side surface 62 of the first combining core 6a. The side portion 91 of the heat sink 9b is in contact with the second side surface 72 and the second side surface 62, but may be separated from the second side surface 72 and the second side surface 62.

Although not illustrated in detail, the side portion 91 of the heat sink 9c illustrated in FIG. 2 extends along the first side surface 71 of the second combining core 7b, the outer side surface 31 of the outer leg core 3a, and the first side surface 61 of the first combining core 6b. The side portion 91 of the heat sink 9d extends along the second side surface 72 of the second combining core 7b, the outer side surface 31 of the outer leg core 3b, and the first side surface 61 of the first combining core 6b.

Next, the method for producing the coil device 1 is described. First, the members illustrated in FIG. 2 are prepared. As illustrated in FIG. 4, the terminals 13c and 13d are integrally formed on the terminal fixing plate 11a, and the terminals 13a and 13b are integrally formed on the terminal fixing plate 11b. Next, as illustrated in FIGS. 3 and 6, the first wire 4 is wound around the outer circumferential surface 23 of the first split core 21 to form the first winding portion 40. The second wire 5 is wound around the outer circumferential surface 24 of the second split core 22 to form the second winding portion 50. Next, the gap member 10 is disposed between the first split core 21 and the second split core 22, and these are bonded together.

Next, as illustrated in FIGS. 2 and 3, the inner surface 65 of the first combining core 6a and the inner surface 65 of the first combining core 6b are bonded to the bottom surface 26 of the second split core 22, and the first combining cores 6a and 6b are combined with the second split core 22. Further, the inner surface 65 of the first combining core 6a and the inner surface 65 of the first combining core 6b are bonded to the bottom surface 33 of the outer leg core 3a, and the first combining cores 6a and 6b are combined with the outer leg core 3a. Further, the inner surface 65 of the first combining core 6a and the inner surface 65 of the first combining core 6b are bonded to the bottom surface 33 of the outer leg core 3b, and the first combining cores 6a and 6b are combined with the outer leg core 3b.

Further, the inner surface 75 of the second combining core 7a and the inner surface 75 of the second combining core 7b are bonded to the top surface 32 of the outer leg core 3a, and the second combining cores 7a and 7b are combined with the outer leg core 3a. Further, the inner surface 75 of the second combining core 7a and the inner surface 75 of the second combining core 7b are bonded to the top surface 32 of the outer leg core 3b, and the second combining cores 7a and 7b are combined with the outer leg core 3b. At this time, the position of the outer leg core 3a is adjusted such that the inner circumferential surface 30 of the outer leg core 3a abuts on the outer circumferential surface 46 of the first winding portion 40 and the outer circumferential surface 56 of the second winding portion 50. The position of the outer leg core 3b is adjusted such that the inner circumferential surface 30 of the outer leg core 3b abuts on the outer circumferential surface 46 of the first winding portion 40 and the outer circumferential surface 56 of the second winding portion 50.

Next, as illustrated in FIGS. 2 and 4, the leadout portion 41a is connected to the wire connecting portion 130 of the terminal 13a. Further, the leadout portion 41b is connected to the wire connecting portion 130 of the terminal 13b. Further, the leadout portion 51a is connected to the wire connecting portion 130 of the terminal 13c. Further, the leadout portion 51b is connected to the wire connecting portion 130 of the terminal 13d. After the first winding portion 40 and the second winding portion 50 are formed, the leadout portion 41a and others may be connected to the wire connecting portion 130.

Next, the heat sinks 9a and 9b are attached to the second combining core 7a with, for example, an adhesive, and the heat sinks 9c and 9d are attached to the second combining core 7b with, for example, an adhesive. Next, the terminal fixing plate 11a is disposed on the pedestal 12 a, and the terminal fixing plate 11b is disposed on the pedestal 12 b. Next, each member described above is accommodated or fixed in the case 8, and the inside of the case 8 is filled with the heat dissipation resin 14. The coil device 1 can be produced as described above.

As illustrated in FIG. 3, in the coil device 1 of the present embodiment, the inner circumferential surface 45 of the first winding portion 40 is in contact with the outer circumferential surface 23 of the first split core 21. The inner circumferential surface 55 of the second winding portion 50 is in contact with the outer circumferential surface 24 of the second split core 22. This prevents a space from being formed between the first winding portion 40 and the first split core 21, and further between the second winding portion 50 and the second split core 22, thereby reducing the size of the coil device 1. This also facilitates direct heat transfer of heat generated in the first winding portion 40 and the second winding portion 50 to the first split core 21 and the second split core 22, respectively, thereby improving the heat dissipation of the coil device 1. As a result, cracks occurring in the middle leg core 2 or the outer leg cores 3a and 3b can be prevented. In addition, no bobbin is interposed between the first winding portion 40 and the first split core 21, and further between the second winding portion 50 and the second split core 22, thereby making it possible to configure the bobbin-less coil device 1. Therefore, the size of the coil device 1 can be reduced by the thickness of the bobbin.

The first wire 4 is directly wound around the outer circumferential surface 23 of the first split core 21, and the second wire 5 is directly wound around the outer circumferential surface 24 of the second split core 22. Therefore, the inner circumferential surface 45 of the first winding portion 40 is in contact with the outer circumferential surface 23 of the first split core 21, and the inner circumferential surface 55 of the second winding portion 50 is in contact with the outer circumferential surface 24 of the second split core 22. This prevents spaces from forming between the first winding portion 40 and the first split core 21, and further between the second winding portion 50 and the second split core 22, thereby effectively reducing the size of the coil device 1 and improving its heat dissipation.

In addition, the inner circumferential surface 30 of the outer leg core 3a is in contact with the outer circumferential surface 46 of the first winding portion 40 and the outer circumferential surface 56 of the second winding portion 50, and the inner circumferential surface 30 of the outer leg core 3b is in contact therewith. This prevents spaces from forming between the first winding portion 40 and the outer leg core 3a, between the second winding portion 50 and the outer leg core 3a, and between the first winding portion 40 and the outer leg core 3b, and further between the second winding portion 50 and the outer leg core 3b. This ensures a heat transfer path between the first winding portion 40 and the outer leg core 3a, between the second winding portion 50 and the outer leg core 3a, and between the first winding portion 40 and the outer leg core 3b and further between the second winding portion 50 and the outer leg core 3b, thereby effectively reducing the size of the coil device 1 and improving its heat dissipation.

The outer leg cores 3a and 3b are configured to be separated from the first combining cores 6a and 6b. Further, the outer leg cores 3a and 3b, the middle leg core 2, and the first combining cores 6a and 6b are separated from each other. Therefore, the outer leg cores 3a and 3b can be disposed more freely, and as described above, the outer leg cores 3a and 3b can be disposed such that the inner circumferential surfaces 30 of the outer leg cores 3a and 3b are in contact with the outer circumferential surface 46 of the first winding portion 40 and the outer circumferential surface 56 of the second winding portion 50. As a result, the above-described effect can be effectively obtained.

### Second Embodiment

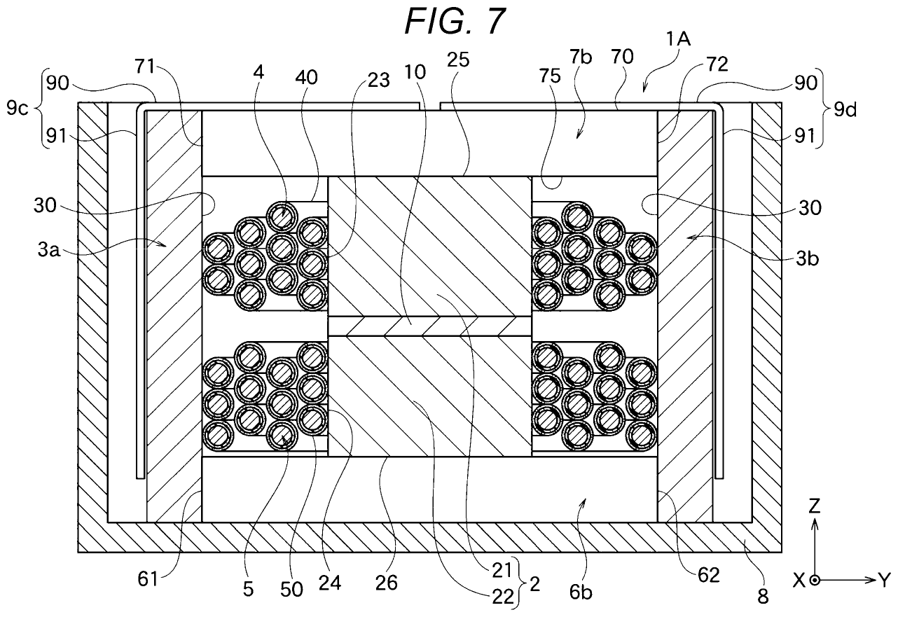

The coil device 1A of the second embodiment illustrated in FIG. 7 has the same configuration as that of the coil device 1 of the first embodiment except for the following points. Portions overlapping with the coil device 1 of the first embodiment are denoted by the same reference numerals, and their detailed description is omitted.

As is clear from comparison between FIGS. 7 and 3, the first combining core 6b and the second combining core 7b are disposed between the outer leg core 3a and the outer leg core 3b, and are sandwiched between the outer leg core 3a and the outer leg core 3b in the Y axis direction. Although not illustrated in detail, the first combining core 6a and the second combining core 7a are disposed between the outer leg core 3a and the outer leg core 3b, and are sandwiched between the outer leg core 3a and the outer leg core 3b in the Y axis direction.

The top surface 25 of the first split core 21 is in contact with the inner surface 75 of the second combining core 7b (as well as the second combining core 7a). However, as in the first embodiment, a gap G may be formed between the top surface 25 of the first split core 21 and the second combining core 7b (second combining core 7a).

Also in the present embodiment, the same effects as those of the first embodiment can be obtained. In addition, in the present embodiment, the height of the coil device 1A (but a portion excluding the case 8) along the Z axis can be matched with the heights of the outer leg cores 3a and 3b along the Z axis. Accordingly, the height of the coil device 1A can be reduced.

Note that the present invention is not limited to the above-described embodiments, and various modifications can be made within the scope of the present invention. For example, in each of the above embodiments, the first winding portion 40 and the second winding portion 50 illustrated in FIG. 3 may be formed of an air-core coil.

In each of the above embodiments, a core may be formed by combining the first E-shaped core and the second E-shaped core. Alternatively, a core may be formed by combining the E-shaped core and the I-shaped core. Alternatively, the core may be formed by combining at least one U-shaped core and at least one I-shaped core.

In each of the above embodiments, as illustrated in FIG. 3, the first winding portion 40 and the second winding portion 50 are disposed along the Z axis, but the second winding portion 50 may be disposed radially outside the first winding portion 40. Alternatively, the first winding portion 40 may be disposed radially outside the second winding portion 50.

As illustrated in FIG. 2, in each of the above embodiments, the coil device 1 includes the two outer leg cores 3a and 3b, but the number of outer leg cores may be one. Although the coil device 1 includes the two first combining cores 6a and 6b, the number of first combining cores may be one. Although the coil device 1 includes the two second combining cores 7a and 7b, the number of second combining cores may be one.

In each of the above embodiments, both the first wire 4 and the second wire 5 are insulated coated wires, but either the first wire 4 or the second wire 5 may be an insulated coated wire.

In each of the above embodiments, as illustrated in FIG. 3, the inner circumferential surfaces 30 of the outer leg cores 3a and 3b are in contact with the outer circumferential surface 46 of the first winding portion 40 and the outer circumferential surface 56 of the second winding portion 50, but a space may be formed therebetween.

In each of the above embodiments, the application example of the present invention to transformers has been described, but the present invention may be applied to coil devices other than transformers.

### REFERENCE SIGNS LIST

1, 1A Coil device
2 Middle leg core
21 First split core
22 Second split core
23, 24 Outer circumferential surface
25 Top surface
26 Bottom surface
3a, 3b Outer leg core
30 Inner circumferential surface
31 Outer side surface
32 Top surface
33 Bottom surface
4 First wire
40 First winding portion
41a, 41b Leadout portion
42 Core portion
43 Coating
44 Fusion layer
45 Inner circumferential surface
46 Outer circumferential surface
5 Second wire
50 Second winding portion
51a, 51b Leadout portion
52 Core portion
53 Coating
54 Fusion layer
55 Inner circumferential surface
56 Outer circumferential surface
6a, 6b First combining core
60 Outer surface
61 First side surface
62 Second side surface
65 Inner surface
66 Recess
7a, 7b Second combining core
70 Outer surface
71 First side surface
72 Second side surface
75 Inner surface
76 Recess
8 Case
80 Bottom portion
81 Side portion
82a, 82b Protrusion
83a, 83b Recess
9a to 9d Heat sink
90 Top plate portion
91 Side portion
10 Gap member
11a, 11b Terminal fixing plate
12a, 12b Pedestal
120 Bottom portion
121 Enclosure portion
122 Case fixing portion
13a to 13d Terminal
130 Wire connecting portion
131 Connection portion
14 Heat dissipation resin

What is claimed is:

1. A coil device comprising:
a first winding portion having a first wire spirally wound;
a second winding portion having a second wire spirally wound;
a middle leg core disposed radially inside the first winding portion and the second winding portion;
an outer leg core disposed radially outside the first winding portion and the second winding portion; and
a first combining core combining the middle leg core to the outer leg core,
wherein at least one of an inner circumferential surface of the first winding portion and an inner circumferential surface of the second winding portion is in contact with an outer circumferential surface of the middle leg core.

2. The coil device according to claim 1, wherein at least one of the first wire and the second wire is directly wound around an outer circumferential surface of the middle leg core.

3. The coil device according to claim 1, wherein an inner circumferential surface of the outer leg core is in contact with at least one of an outer circumferential surface of the first winding portion and an outer circumferential surface of the second winding portion.

4. The coil device according to claim 1, wherein the outer leg core is configured to be separated from the middle leg core.

5. The coil device according to claim 4, wherein the middle leg core is configured to be separated from the first combining core.

6. The coil device according to claim 5, wherein the outer leg core is configured to be separated from the first combining core.

7. The coil device according to claim 1, wherein
the middle leg core comprises a first split core having the first wire spirally wound, and a second split core formed separately from the first split core and having the second wire spirally wound, and
a first gap is formed between the first split core and the second split core.

8. The coil device according to claim 1, further comprising
a second combining core facing the first combining core along the axial direction of the middle leg core, wherein
a second gap is formed between an axial end of the middle leg core and the second combining core.

9. The coil device according to claim 1, wherein
at least one of the first wire and the second wire is an insulated coated wire, and
a coating of the insulated coated wire of at least one of the first winding portion and the second winding portion is covered with a resin.

10. The coil device according to claim 1, further comprising
a case accommodating the middle leg core and the outer leg core, wherein
the case is filled with a heat dissipation resin so as to cover the first winding portion and the second winding portion.

11. The coil device according to claim 1, further comprising:
a first combining core coupling the middle leg core with the outer leg core;
a second combining core facing the first combining core along the axial direction of the middle leg core; and
a heat sink having a top plate portion disposed along a top surface of the second combining core and a side portion disposed along a side surface of the second combining core perpendicular to the top surface.
